(19) United States
(12) Patent Application Publication
(10) Pub. No.: US 2010/0295490 A1
(43) Pub. Date: Nov. 25, 2010

(54) MOTOR DRIVE APPARATUS AND MOTOR DRIVE METHOD

(76) Inventors: Shinichi Kuroshima, Osaka (JP); Hideki Nishino, Osaka (JP); Noriaki Emura, Osaka (JP)

Correspondence Address: MCDERMOTT WILL & EMERY LLP, 600 13TH STREET, NW, WASHINGTON, DC, 20005-3096, US

(21) Appl. No.: 12/711,009

(22) Filed: Feb. 23, 2010

(30) Foreign Application Priority Data
May 25, 2009 (JP) 2009-125021

(51) Int. Cl. H02P 6/18

(52) U.S. Cl. 318/400.35

(57) ABSTRACT

A zero-crossing detector compares a neutral node voltage of a motor with a back electromotive force of at least one of windings and outputs a first signal every time a zero-crossing is detected as a result of the comparison. A cycle detector detects a cycle of the first signal and outputs a second signal during a final portion of the cycle. A de-energizer de-energizes all the windings of the motor during at least a period of time that the second signal is being output. The zero-crossing detector performs detection of a zero-crossing during the period of time that the second signal is being output.

### CROSS-REFERENCE TO RELATED APPLICATION

This application claims priority to Japanese Patent Application No. 2009-125021 filed on May 25, 2009, the disclosure of which including the specification, the drawings, and the claims is hereby incorporated by reference in its entirety.

### BACKGROUND

The present disclosure relates to apparatuses and methods for driving motors. More specifically, the present disclosure relates to a motor drive apparatus and method for PWM control of energization of each of windings of a sensorless motor.

In recent years, brushless motors are commonly used as spindle motors in hard disk drives, optical disk drives and the like, fan motors and compressor drive motors in air conditioners, and the like. Brushless motors are typically PWM-driven using an inverter apparatus so as to perform variable speed control over a wide range or reduce power consumption.

In brushless motors having a three-phase winding, a position sensor such as a Hall-effect device or the like is typically disposed at intervals of 120 electrical degrees so as to detect a position of a magnetic pole of a rotor. On the other hand, a variety of sensorless motors have been developed so as to reduce the cost or size. In some sensorless motors, a position of a rotor is detected by performing 120 electrical degree energization, and comparing a neutral node voltage of the motor with a back electromotive force induced during a de-energized phase, to detect a zero-crossing. However, when the position of a rotor is detected using this method, this energization technique theoretically induces the maximum torque in the sensorless motor, and therefore, it is necessary to reduce a motor drive current within a low-rotational speed range. Moreover, as the rotational speed is decreased, the amplitude of the back electromotive force decreases, so that it is more difficult to detect the rotor position, likely leading to loss of synchronization.

Conventionally, various techniques have been proposed for stably driving a sensorless motor at low rotational speed. For example, a signal which is obtained by delaying the back electromotive force using a CR filter may be used as a rotor position signal, and the signal which is further delayed by 60 degrees may be used as a rotor position signal within a low-rotational speed range (see, for example, Japanese Laid-Open Patent Publication No. 2004-304905). Alternatively, zero-crossings of the back electromotive force may be detected and the cycle of the back electromotive force may be calculated and stored by a microprocessor in advance, and when a zero-crossing of the back electromotive force fails to be detected, commutation control may be performed using a cycle which is slightly longer than the stored cycle (see, for example, Japanese Laid-Open Patent Publication No. 2007-110784). Alternatively, although low-rotational speed drive is not intended, zero-crossings may be detected while a target phase to be detected is de-energized, so as to prevent erroneous detection of a zero-crossing (see, for example, Japanese Laid-Open Patent Publication No. 2007-267552).

### SUMMARY

The phase delay of the rotor position with respect to the back electromotive force depends on the rotational speed of the rotor. Therefore, when a signal which is obtained by delaying the back electromotive force by a predetermined amount using a CR filter is used as a rotor position signal, the generated torque varies depending on the rotational speed, and therefore, it is difficult to stably drive the motor, particularly within a low-rotational speed range. Moreover, as described above, it is difficult to detect a zero-crossing of the back electromotive force within a low-rotational speed range. Therefore, if a zero-crossing of the back electromotive force cannot be detected and commutation control is continued based on a calculated zero-crossing of the back electromotive force, an error between the actual zero-crossing and the calculated zero-crossing of the back electromotive force gradually increases, and therefore, the timing of the commutation control gradually deviates from normal timing, likely leading to loss of synchronization. In view of the aforementioned problems, the detailed description describes implementations of motor drive apparatuses which stably drive a sensorless motor within a low-rotational speed range.

An example motor drive apparatus for PWM control of energization of each of windings of a sensorless motor includes a zero-crossing detector configured to compare a neutral node voltage of the motor with a back electromotive force of at least one of the windings and output a first signal every time a zero-crossing is detected as a result of the comparison, a cycle detector configured to detect a cycle of the first signal and output a second signal during a final portion of the cycle, and a de-energizer configured to de-energize all the windings of the motor during at least a period of time that the second signal is being output. The zero-crossing detector performs detection of a zero-crossing during the period of time that the second signal is being output.

Another example motor drive apparatus for PWM control of energization of each of windings of a sensorless motor includes a zero-crossing detector configured to compare a neutral node voltage of the motor with a back electromotive force of at least one of the windings and output a first signal every time a zero-crossing is detected as a result of the comparison, a cycle detector configured to detect a cycle of the first signal and output a second signal during a final portion of the cycle, and a torque command generator configured to cause a torque command with respect to the motor to be zero during at least a period of time that the second signal is being output. The zero-crossing detector performs detection of a zero-crossing during the period of time that the second signal is being output.

### BRIEF DESCRIPTION OF THE DRAWINGS

FIG. 1 is a diagram showing a configuration of a motor drive apparatus according to a first embodiment.

FIG. 2 is a timing chart showing a relationship between energized phase signals, a window signal, and winding currents.

FIG. 3 is a diagram showing a configuration of a zero-crossing detector.

FIG. 4 is a diagram showing waveforms of signals relating to the zero-crossing detector.

FIG. 5 is a diagram showing a configuration of an energized phase switching unit.

FIG. 6 is a timing chart showing a relationship between a zero-crossing detection signal and energized phase signals.

FIG. 7 is a diagram showing a configuration of a cycle detector.

FIG. 8 is a timing chart showing a relationship between a zero-crossing detection signal, output pulses of a division cycle timer, and a window signal.

FIG. 9 is a diagram showing a configuration of the cycle detector.

FIG. 10 is a diagram showing a configuration of a motor drive apparatus according to a second embodiment.

FIG. 11 is a timing chart showing a relationship between a torque command, energized phase signals, a window signal, and winding currents.

FIG. 12 is a diagram showing a configuration of a zero-crossing detector.

FIG. 13 is a diagram showing waveforms of signals relating to the zero-crossing detector.

FIG. 14 is a diagram showing a configuration of an energized phase switching unit.

FIG. 15 is a timing chart showing a relationship between a zero-crossing detection signal, a phase switching signal, and energized phase signals.

FIG. 16 is a diagram showing a configuration of a cycle detector.

FIG. 17 is a diagram showing a configuration of a torque command generator.

FIG. 18 is a timing chart showing a relationship between a zero-crossing detection signal, a phase switching signal, division cycle signals, a window signal, and a torque command.

### DETAILED DESCRIPTION

### First Embodiment

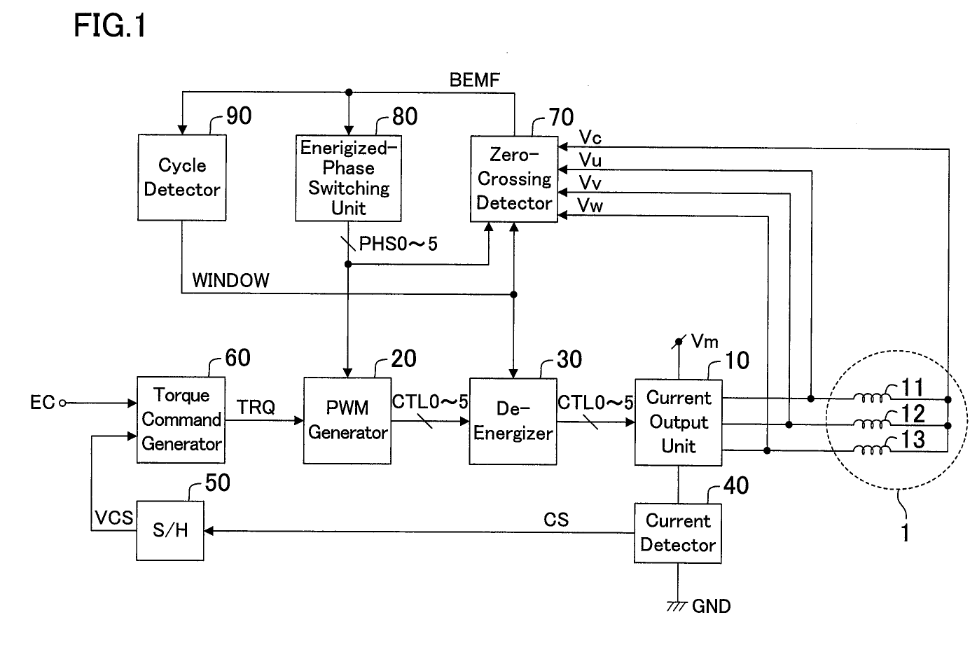

FIG. 1 shows a configuration of a motor drive apparatus according to a first embodiment. For the sake of convenience, a motor 1 which is to be driven by the motor drive apparatus of this embodiment is assumed to be a three-phase sensorless motor. Specifically, the motor 1 includes a rotor (not shown) having a field unit including a permanent magnet, and a stator including a U-phase winding 11, a V-phase winding 12 and a W-phase winding 13, which are Y-connected.

A current output unit 10 supplies a drive current to the windings 11 to 13 of the motor 1 in accordance with PWM control signals CTL0 to CTL5 which are generated by a PWM generator 20 and are input to the current output unit 10 via a de-energizer 30. Specifically, the current output unit 10 may include three half-bridges each of which includes two switching devices coupled in series between a power source Vm and a ground GND, and which are connected in parallel, corresponding to the three respective phases. The switching of the switching devices is controlled in accordance with the respective the PWM signals CTL0 to CTL5. A current detector 40 detects a current which flows from the power source Vm via the current output unit 10 and the windings 11 to 13 of the motor 1 to the ground GND, and outputs a current detection signal CS. Specifically, the current detector 40 can be comprised of a resistance device. In this case, the voltage across the resistance device is the current detection signal CS. A sample/hold unit 50 smoothes the current detection signal CS to generate a current detection signal VCS. A torque command generator 60 generates a torque command TRQ based on an external input command EC and the current detection signal VCS. Specifically, the torque command generator 60 can be comprised of a differential amplifier which amplifies an error between the current detection signal VCS and the external input command EC.

The PWM generator 20 generates the PWM control signals CTL0 to CTL5 which allow 120 electrical degree energization with respect to the windings 11 to 13, based on the torque command TRQ and energized phase signals PHS0 to PHS5 each of which is exclusively at a predetermined logic level (e.g., a high level) during a period of time corresponding to 60 electrical degrees. The de-energizer 30 passes the PWM control signals CTL0 to CTL5 when a window signal WINDOW described later is not being output, and causes all the PWM control signals CTL0 to CTL5 to be in the high impedance state (i.e., interrupts all the PWM control signals CTL0 to CTL5) when the window signal WINDOW is being output. Specifically, the de-energizer 30 can be comprised of a logic circuit which performs a logical operation between each of the PWM control signals CTL0 to CTL5 and the window signal WINDOW.

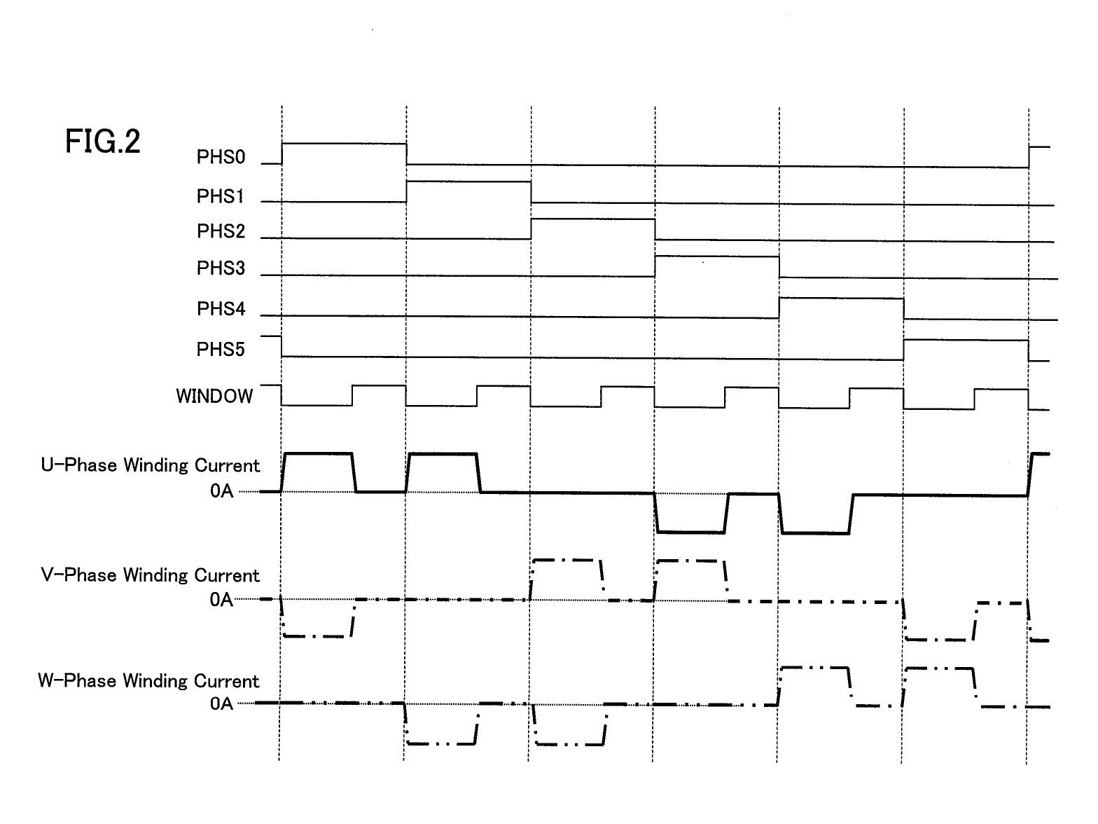

FIG. 2 shows a relationship between the energized phase signals PHS0 to PHS5, the window signal WINDOW, and currents flowing through the windings 11 to 13. Note that the torque command TRQ is assumed to be constant. The direction of energization is determined, depending on which of the energized phase signals PHS0 to PHS5 is high. For example, when the energized phase signal PHS0 is high, a current flows from the U-phase winding 11 to the V-phase winding 12. When the energized phase signal PHS1 is high, a current flows from the U-phase winding 11 to the W-phase winding 13. When the window signal WINDOW is being output, i.e., the window signal WINDOW is high, all the PWM control signals CTL0 to CTL5 are interrupted and all the windings of the motor 1 are de-energized.

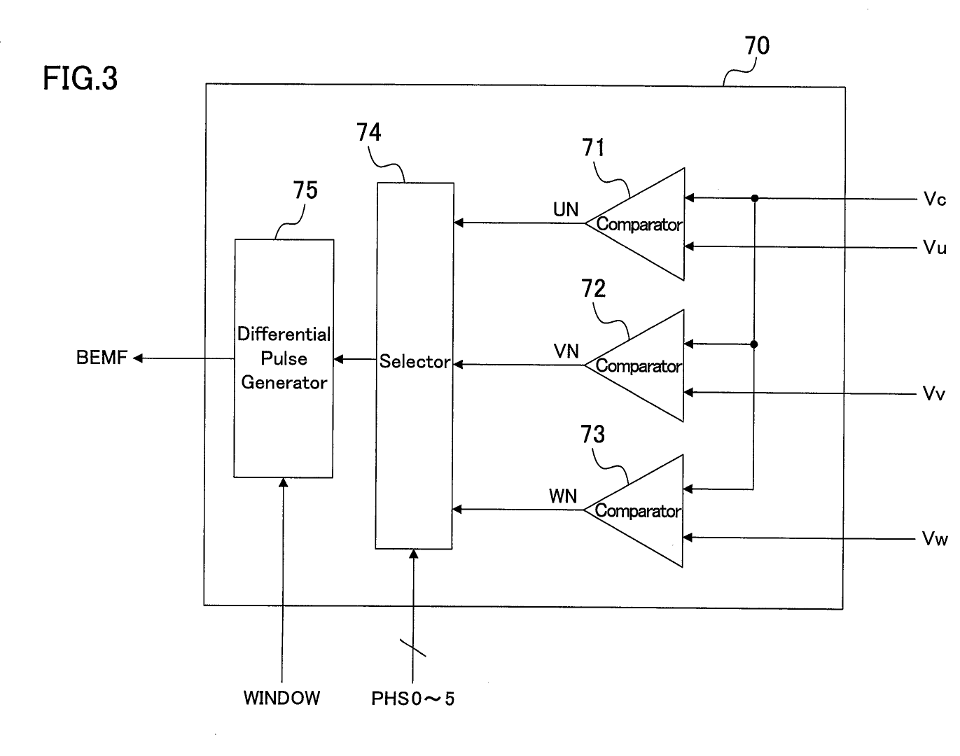

Referring back to FIG. 1, a zero-crossing detector 70 compares a neutral node voltage Vc of the motor 1 with back electromotive forces Vu, Vv and Vw of the windings 11 to 13, and outputs a detection signal BEMF every time a zero-crossing is detected in each back electromotive force. FIG. 3 shows an example configuration of the zero-crossing detector 70. Comparators 71, 72 and 73 compare the back electromotive forces Vu, Vv and Vw with the neutral node voltage Vc, and output comparison results UN, VN and WN, respectively. A selector 74 outputs one of the input comparison results UN, VN and WN in accordance with the energized phase signals PHS0 to PHS5. A differential pulse generator 75, when the window signal WINDOW is high, detects a change in the output of the selector 74 and outputs a pulse signal, i.e., the detection signal BEMF.

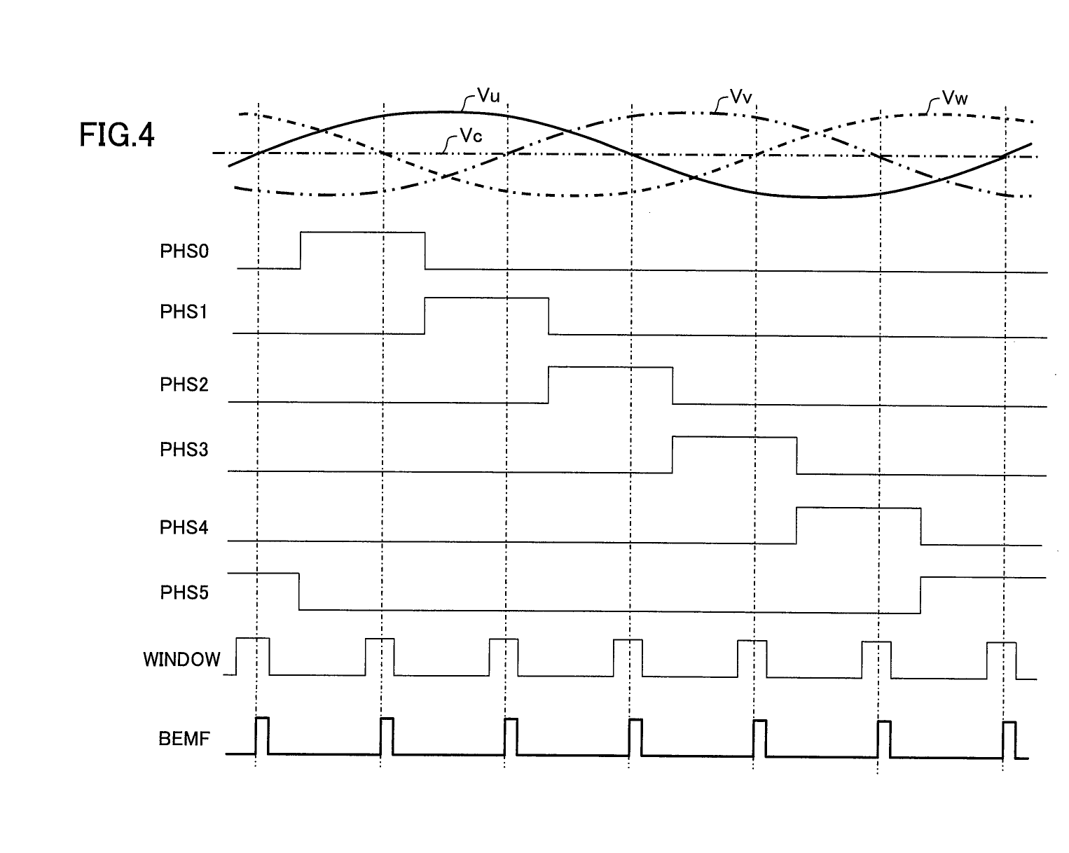

FIG. 4 shows waveforms of signals relating to the zero-crossing detector 70. Note that, for the sake of convenience, it is assumed that the neutral node voltage Vc is a constant voltage, and the back electromotive forces Vu, Vv and Vw are sine waves whose center is the neutral node voltage Vc. For example, when the energized phase signal PHS0 is high, the selector 74 selects the comparison result WN, and in this case, when the window signal WINDOW is high, the differential pulse generator 75 outputs the detection signal BEMF at the timing of a falling edge of the comparison result WN. When the energized phase signal PHS1 is high, the selector 74 selects the comparison result VN, and in this case, when the window signal WINDOW is high, the differential pulse generator 75 outputs the detection signal BEMF at the timing of a rising edge of the comparison result VN. Specifically, the zero-crossing detector 70 detects all zero-crossings of the back electromotive forces of all the windings that occur when the back electromotive forces are changed from a positive level to a negative level and from a negative level to a positive level. Therefore, the detection signal BEMF is output at intervals of 60 electrical degrees, i.e., six times per 360-electrical degree cycle.

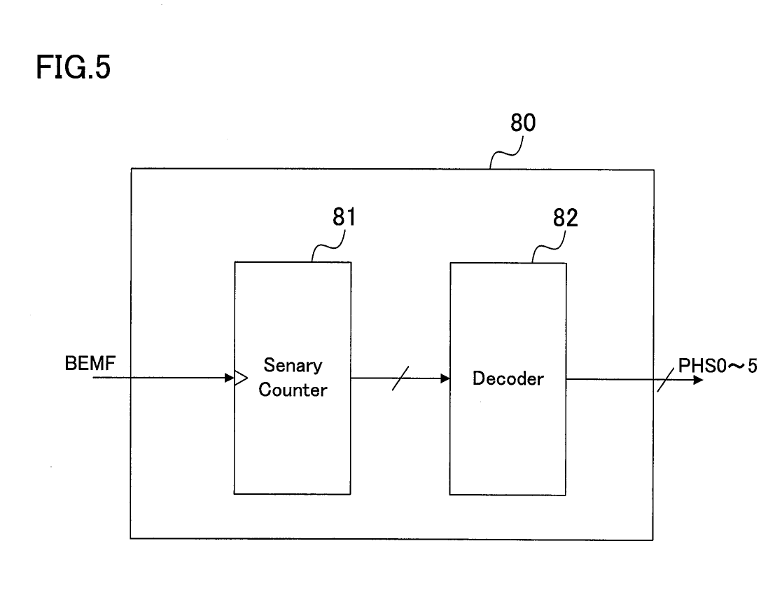

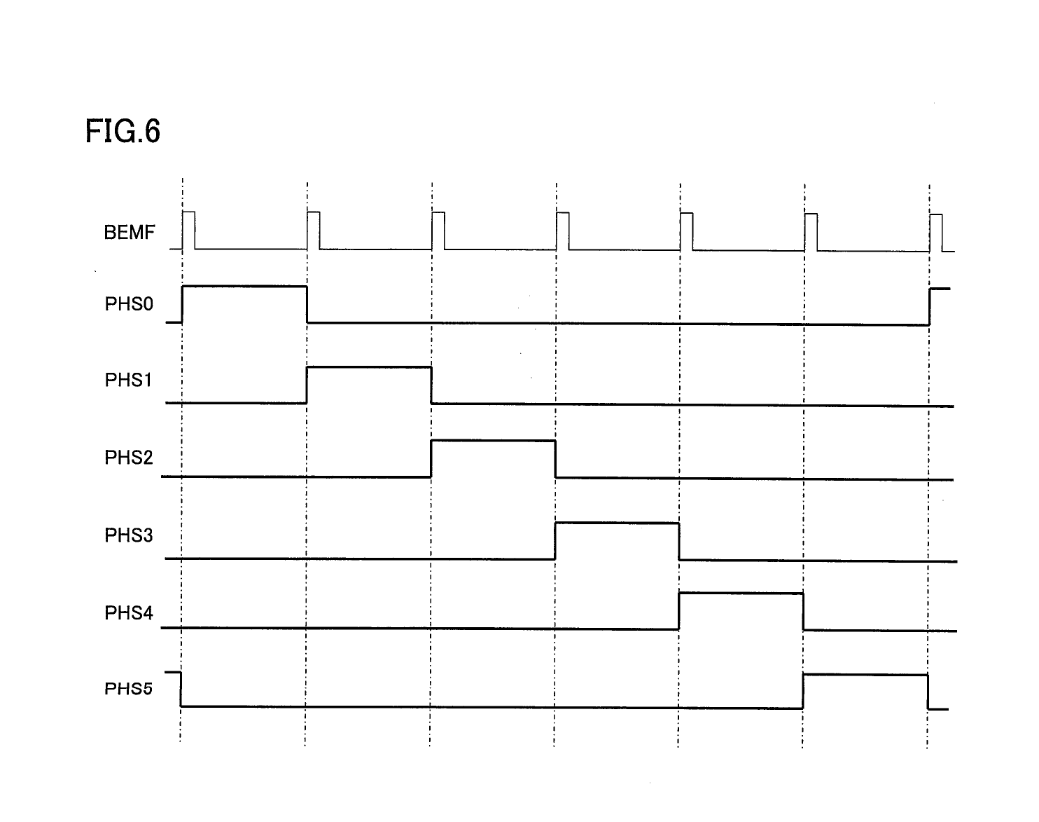

Referring back to FIG. 1, an energized phase switching unit 80 generates the energized phase signals PHS0 to PHS5 based on the detection signal BEMF. FIG. 5 shows an example configuration of the energized phase switching unit 80. The energized phase switching unit 80 can be comprised of a senary counter 81 which counts the detection signal BEMF, and a decoder 82 which generates the energized phase signals PHS0 to PHS5 based on an output of the senary counter 81. FIG. 6 shows a relationship between the detection signal BEMF and the energized phase signals PHS0 to PHS5. The energized phase signals PHS0 to PHS5 successively go high every time the detection signal BEMF is output. Note that, as there is a dependency relationship between the detection signal BEMF and the energized phase signals PHS0 to PHS5, the energized phase signals PHS0 to PHS5 are generated at a predetermined frequency during activation irrespective of the detection signal BEMF. As a result, after the motor 1 starts rotating, the detection signal BEMF starts being output.

When the rising and falling of the energized phase signals PHS0 to PHS5 are almost the same as zero-crossing detection timings, it is likely that the zero-crossing detection timing is deviated from a period of time during which the window signal WINDOW is being output due to, for example, an offset of the comparators 71 to 73 in the zero-crossing detector 70, and therefore, a zero-crossing cannot be detected. Therefore, for example, the detection signal BEMF may be input to the senary counter 81 after being delayed, thereby delaying the energized phase signals PHS0 to PHS5. As a result, a sufficient margin for zero-crossing detection can be provided.

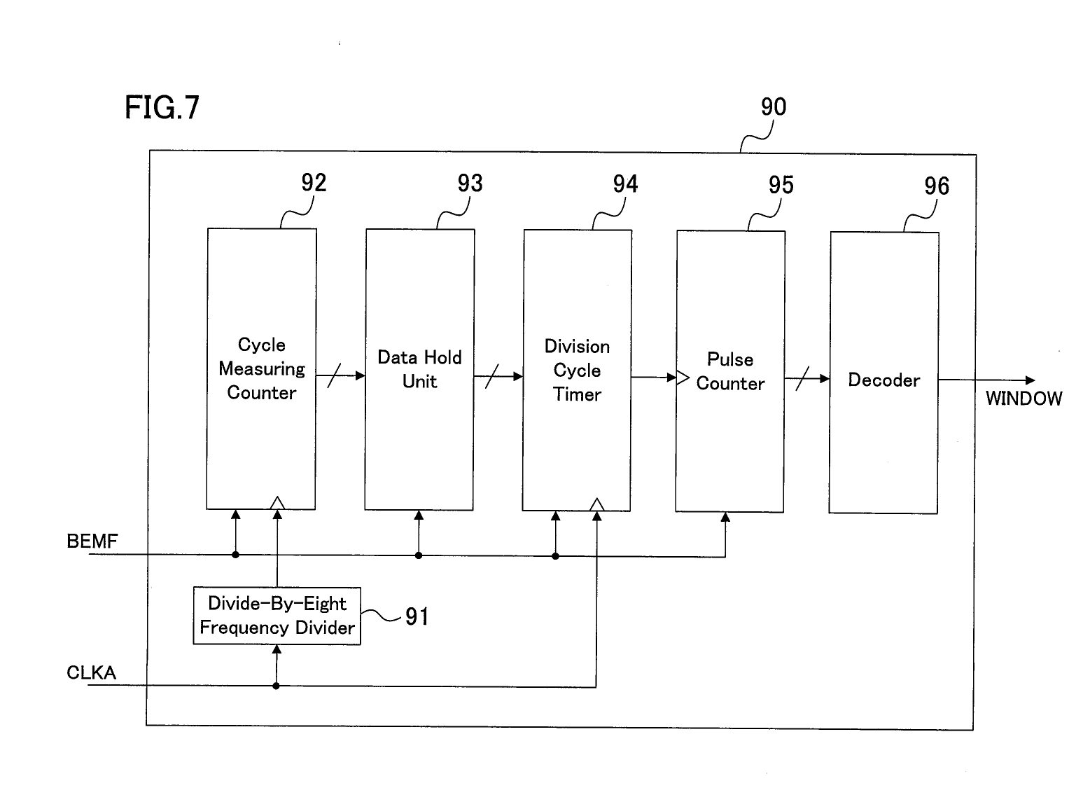

Referring back to FIG. 1, a cycle detector 90 detects a cycle of the detection signal BEMF, and outputs the window signal WINDOW during a period to time corresponding to a final portion of the cycle. FIG. 7 shows an example configuration of the cycle detector 90. A divide-by-eight frequency divider 91 divides, by eight, a clock signal CLKA having a frequency which is sufficiently higher than that of the detection signal BEMF. A cycle measuring counter 92 is reset every time it receives the detection signal BEMF and counts output pulses of the divide-by-eight frequency divider 91 from an initial value. A data hold unit 93 holds a value of the cycle measuring counter 92 every time it receives the detection signal BEMF. A division cycle timer 94 sets a value of the data hold unit 93 as a target value every time it receives the detection signal BEMF, and outputs a pulse every time the number of counted pulses of the clock signal CLKA reaches the target value. A pulse counter 95 is reset every time it receives the detection signal BEMF and counts output pulses of the division cycle timer 94 from an initial value. A decoder 96 outputs a high-level signal, i.e., the window signal WINDOW from when the value of the pulse counter 95 reaches a predetermined value and until the pulse counter 95 is next reset.

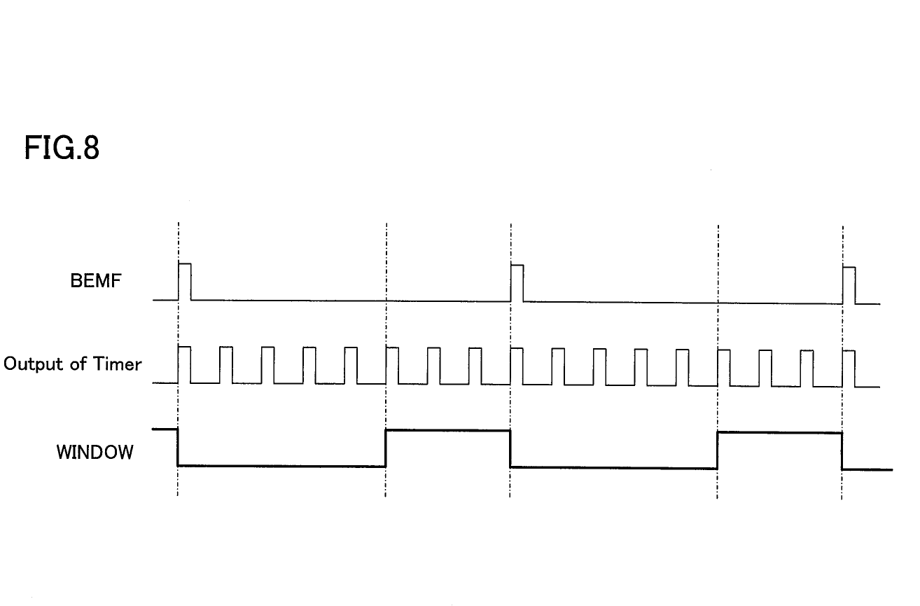

FIG. 8 shows a relationship between the detection signal BEMF, output pulses of the division cycle timer 94, and the window signal WINDOW. The output pulses of the division cycle timer 94 correspond to pulses which are obtained by dividing one cycle of the detection signal BEMF into eight equal parts. Assuming that the initial value of the pulse counter 95 is zero, the decoder 96 outputs the window signal WINDOW during a period of time that the value of the division cycle timer 94 is five to seven. In other words, the window signal WINDOW is obtained by combining the final three phase parts each of which is obtained by equally dividing by eight.

The number by which one cycle of the detection signal BEMF is divided is not limited to eight. One cycle of the detection signal BEMF may be divided into n equal phases, and the final m of the n phases may be combined to generate the window signal WINDOW.

As described above, according to this embodiment, a period of time during which a current is not passed through any of the windings of a motor (de-energization-in-all-phases period) is provided, whereby the motor can be stably driven within a low-rotational speed range using a torque whose average value is reduced without controlling a small current. In addition, a zero-crossing of the back electromotive force is detected during the de-energization-in-all-phases period, and therefore, the zero-crossing can be more accurately detected without being affected by noise, whereby the motor can be more stably driven at low rotational speed.

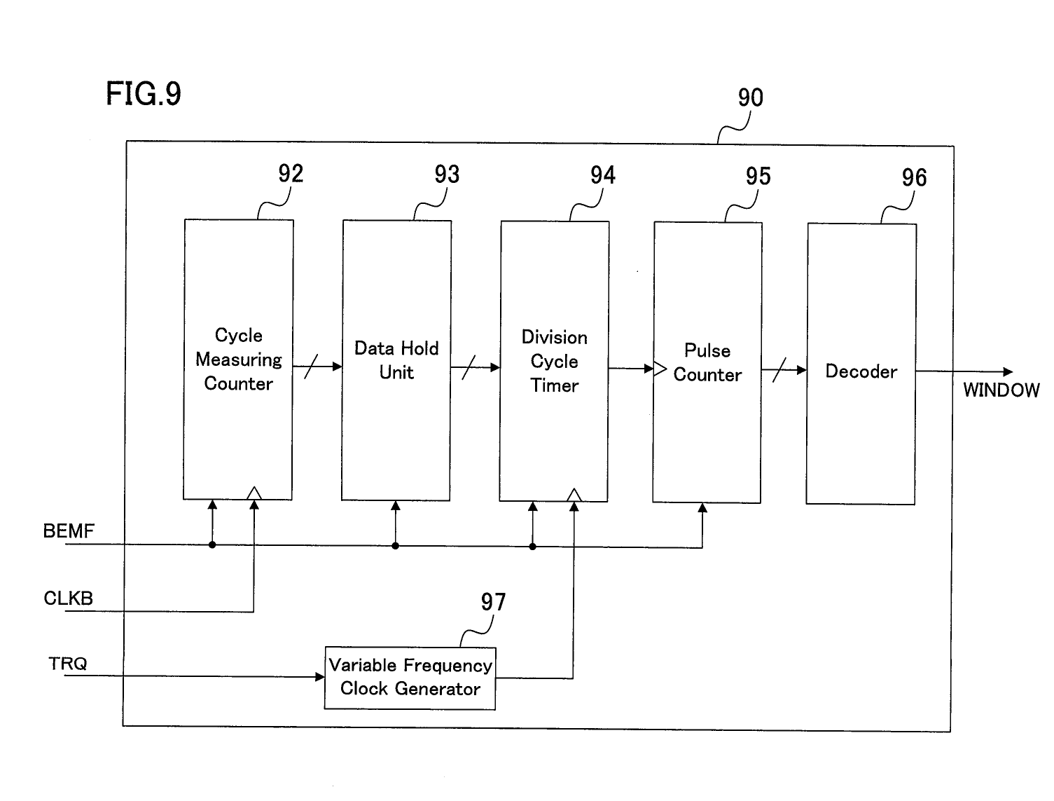

Note that the period of time during which the window signal WINDOW is being output may be changed in accordance with the torque command TRQ. FIG. 9 shows an example configuration of the cycle detector 90. The cycle measuring counter 92 counts pulses of a clock signal CLKB. A variable frequency clock generator 97 generates a clock signal having a frequency which is changed in accordance with the torque command TRQ. Specifically, when the torque command TRQ is large, the frequency is low, and when the torque command TRQ is small, the frequency is high. The division cycle timer 94 counts output pulses of the variable frequency clock generator 97. With this configuration, when the torque command TRQ is increased, the output time period of the window signal WINDOW is decreased, and when the torque command TRQ is decreased, the output time period of the window signal WINDOW is increased. As a result, as the torque command TRQ is decreased, the de-energization-in-all-phases period is increased, whereby the torque can be more effectively reduced.

Moreover, the de-energizer 30 may be provided between the power source Vm and the current output unit 10 so as to disconnect the power source Vm from the current output unit 10. Alternatively, the de-energizer 30 may be provided between the torque command generator 60 and the PWM generator 20 so as to cause the torque command TRQ to be in the high impedance state. Alternatively, the de-energizer 30 may be provided before the torque command generator 60 so as to cause the external input command EC to be in the high impedance state. Alternatively, the de-energizer 30 may be provided between the energized phase switching unit 80 and the PWM generator 20 so as to cause the energized phase signals PHS0 to PHS5 to be in the high impedance state.

### Second Embodiment

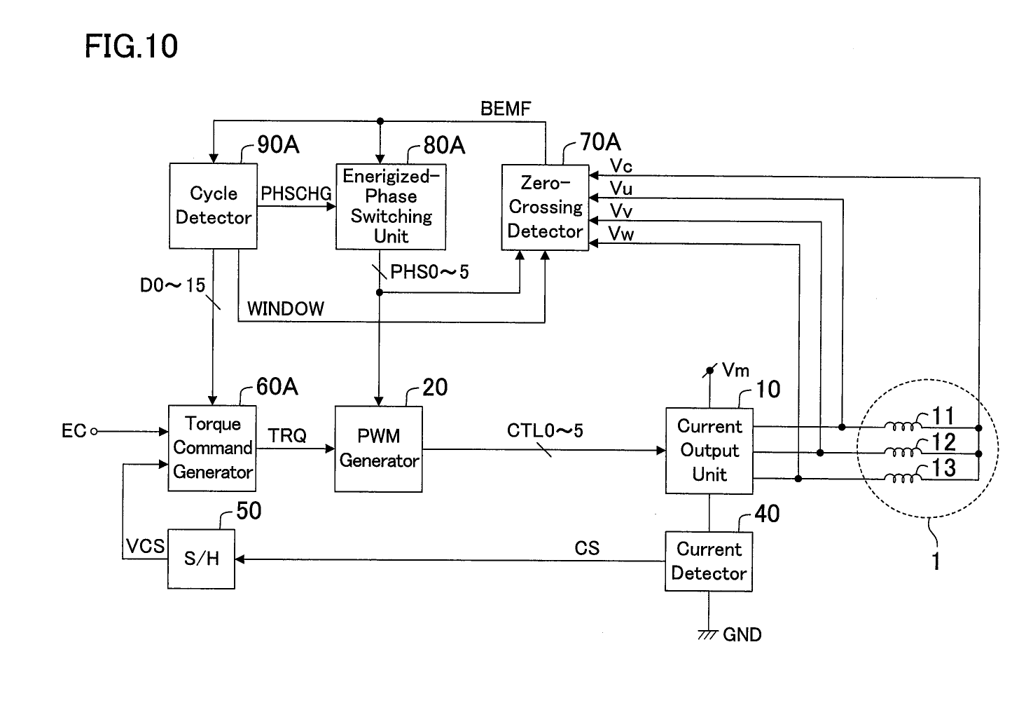

FIG. 10 shows a configuration of a motor drive apparatus according to a second embodiment. In the motor drive apparatus of this embodiment, the torque command TRQ is operated to set the de-energization-in-all-phases period. Only the difference from the first embodiment will be described hereinafter.

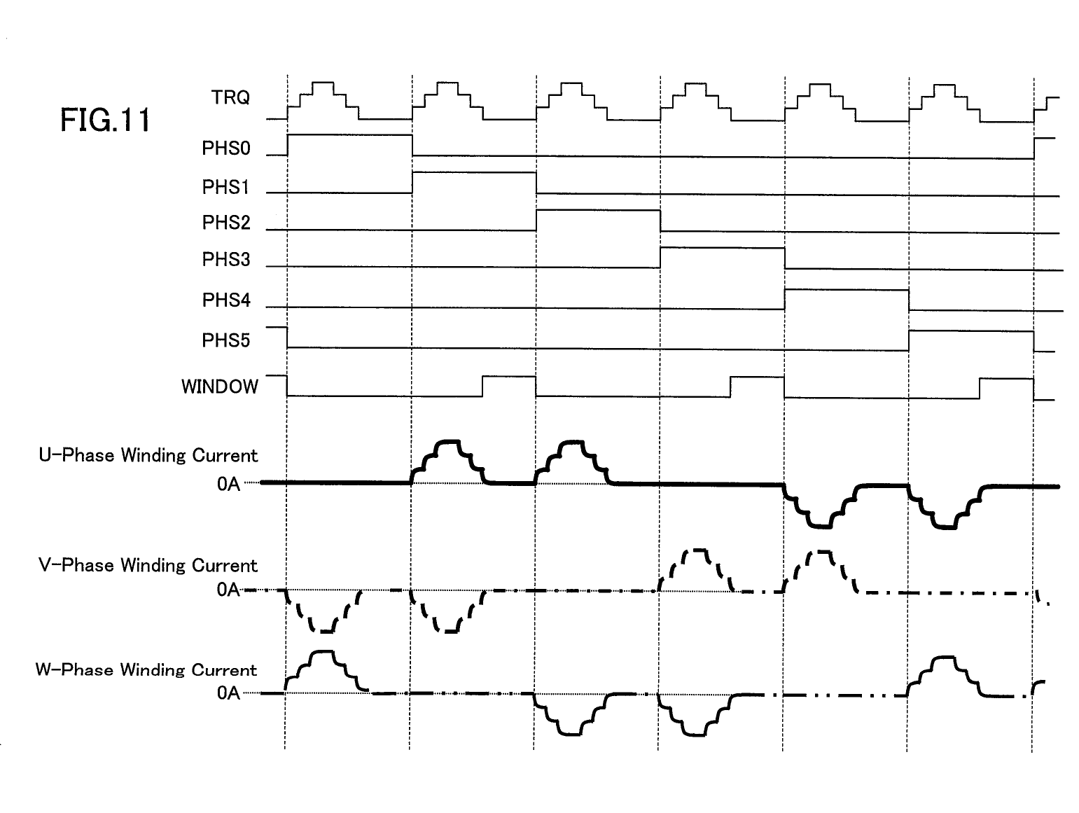

FIG. 11 shows a relationship between the torque command TRQ, the energized phase signals PHS0 to PHS5, the window signal WINDOW, and currents flowing through the windings 11 to 13. The torque command TRQ regularly repeatedly increases, decreases and remains constant at a reference value at cycles of 60 electrical degrees. Therefore, the current of each winding is changed, depending on the waveform of the torque command TRQ. The window signal WINDOW is output at cycles of 120 electrical degrees. When the window signal WINDOW is being output, i.e., the window signal WINDOW is high, the PWM control signals CTL0 to CTL5 are all interrupted to de-energize all the windings of the motor 1.

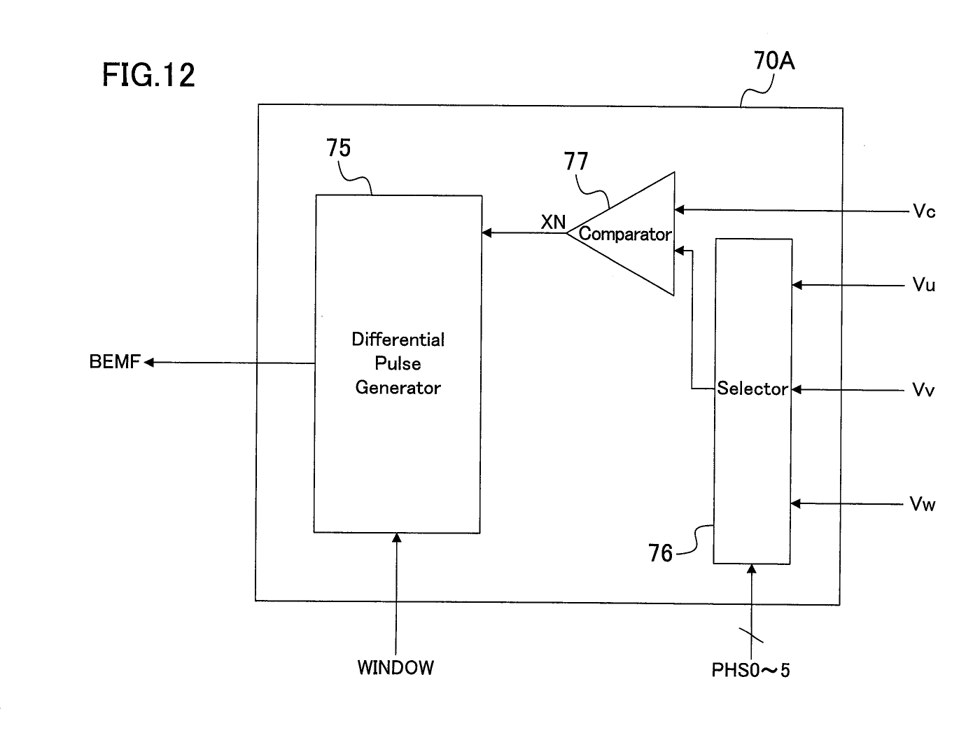

FIG. 12 shows an example configuration of a zero-crossing detector 70A. A selector 76 outputs one of the back electromotive forces Vu, Vv and Vw in accordance with the energized phase signals PHS0 to PHS5. A comparator 77 compares the output of the selector 76 with the neutral node voltage Vc and outputs a comparison result XN. The differential pulse generator 75, when the window signal WINDOW is high, detects a change in the output of the comparator 77 to output a pulse signal, i.e., a detection signal BEMF. Thus, the single comparator 77 is shared for detection of zero-crossings of the phases, whereby an error in zero-crossing detection due to variations in the offset of the comparator can be reduced as compared to when the same number of comparators as that of phases are provided.

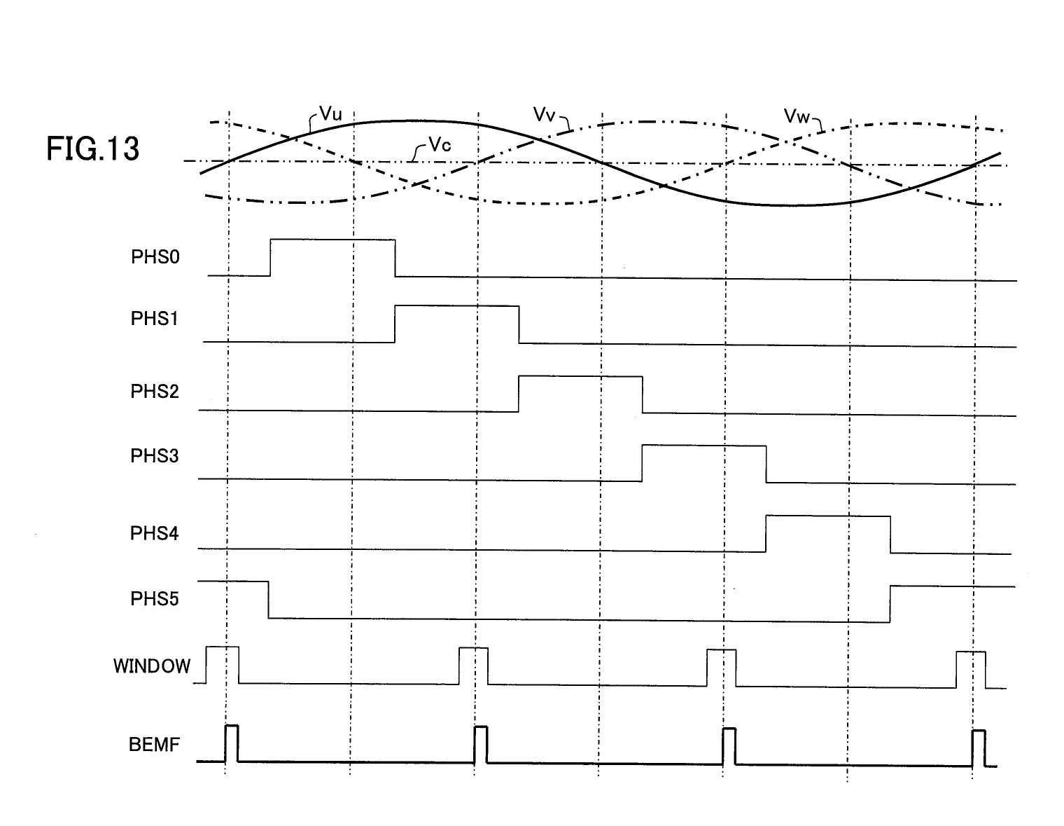

FIG. 13 shows waveforms of signals relating to the zero-crossing detector 70A. Note that, for the sake of convenience, it is assumed that the neutral node voltage Vc is a constant voltage, and the back electromotive forces Vu, Vv and Vw are sine waves whose center is the neutral node voltage Vc. For example, when the energized phase signal PHS1 is high, the selector 76 selects the back electromotive force Vv, and in this case, when the window signal WINDOW is high, the differential pulse generator 75 outputs the detection signal BEMF at the timing of a rising edge of the comparison result XN. When the energized phase signal PHS3 is high, the selector 76 selects the back electromotive force Vw, and in this case, when the window signal WINDOW is high, the differential pulse generator 75 outputs the detection signal BEMF at the timing of a rising edge of the comparison result XN. In other words, the zero-crossing detector 70A detects all zero-crossings that occur when the back electromotive forces of all the windings are changed from a negative value to a positive value. Therefore, the detection signal BEMF is output at intervals of 120 electrical degrees, i.e., three times per 360-electrical degree cycle.

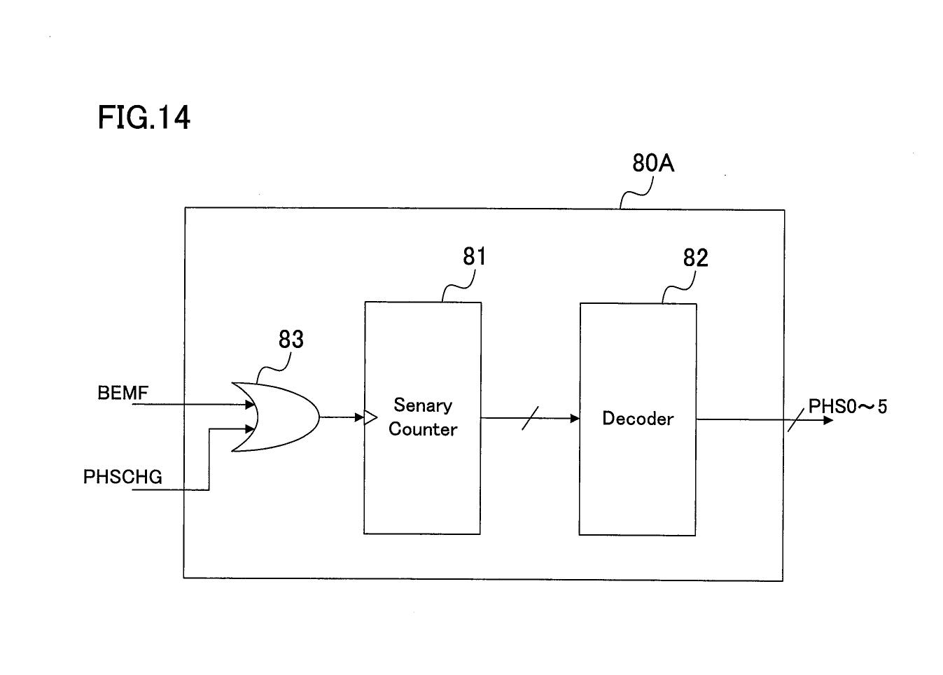

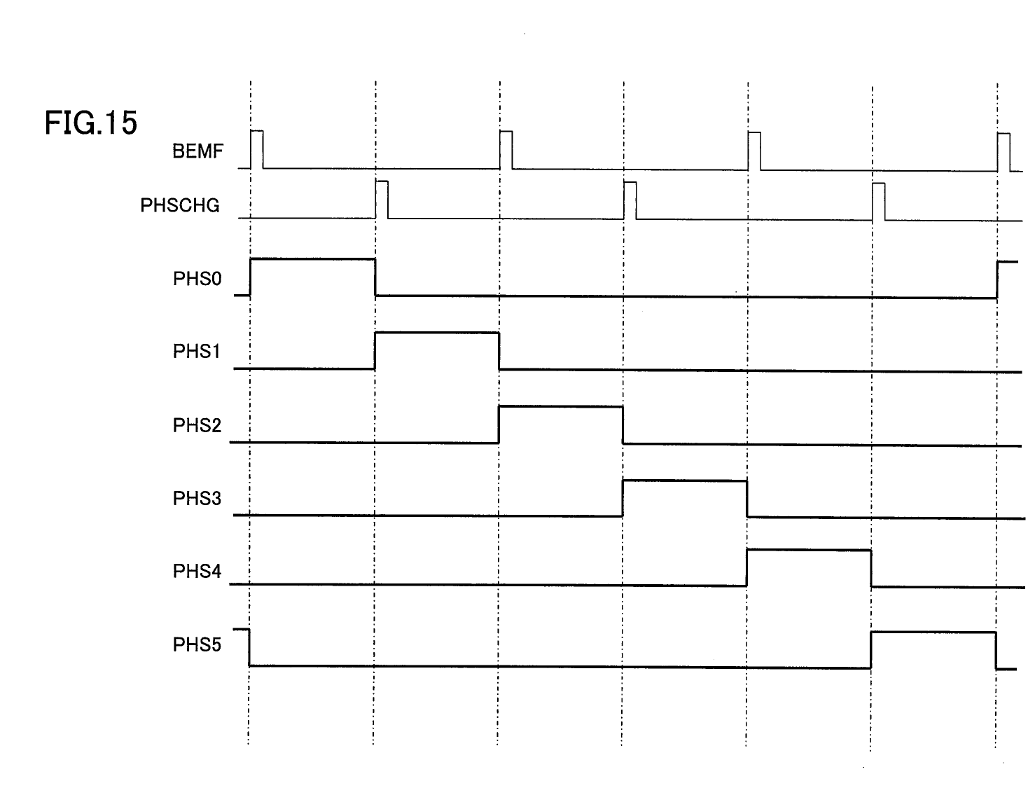

FIG. 14 shows an example configuration of the energized phase switching unit 80A. The energized phase switching unit 80A can be comprised of an OR gate 83 which generates the logical OR of the detection signal BEMF and a phase switching signal PHSCHG, which are shifted from each other by a half cycle, a senary counter 81 which counts outputs of the OR gate 83, and a decoder 82 which generates the energized phase signals PHS0 to PHS5 based on an output of the senary counter 81. FIG. 15 shows a relationship between the detection signal BEMF, the phase switching signal PHSCHG, and the energized phase signals PHS0 to PHS5. The energized phase signals PHS0 to PHS5 successively go high every time the detection signal BEMF or the phase switching signal PHSCHG is output.

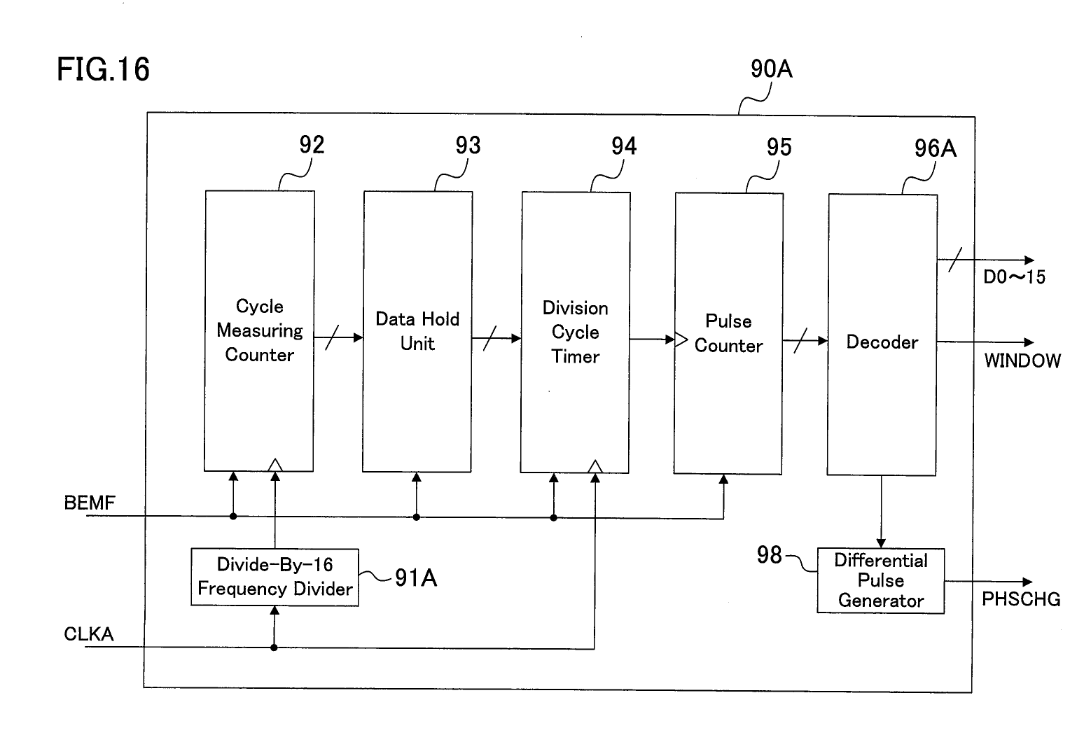

FIG. 16 shows an example configuration of the cycle detector 90A. The cycle detector 90A is the same as the cycle detector 90 of FIG. 7, except that the divide-by-eight frequency divider 91 is replaced with a divide-by-16 frequency divider 91A, and a differential pulse generator 98 which generates a phase detection signal PHSCHG is provided. The decoder 96A divides one cycle of the detection signal BEMF into 16 parts and outputs division cycle signals D0 to D15 which successively go high, and outputs the window signal WINDOW during a period of time that the division cycle signals D13 to D15 are high. The differential pulse generator 98 detects a rising change in the division cycle signal D8 received from the decoder 96A to output a pulse signal, i.e., the phase switching signal PHSCHG.

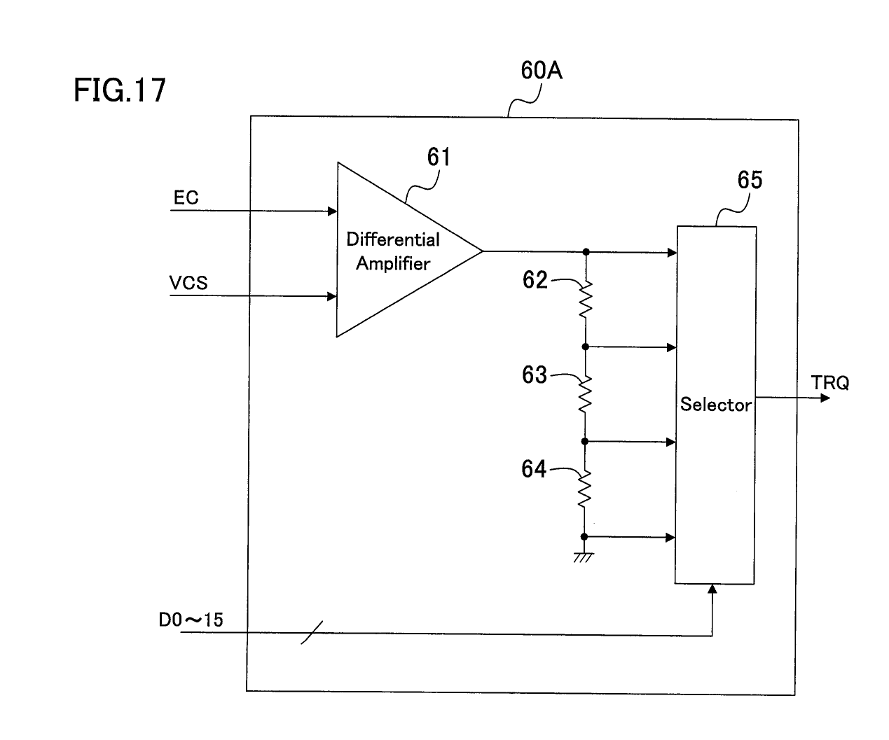

FIG. 17 shows an example configuration of a torque command generator 90A. A differential amplifier 61 amplifies an error between the current detection signal VCS and the external input command EC. The output voltage of the differential amplifier 61 is divided by resistors 62, 63 and 64 which are coupled in series. A selector 65 appropriately switches the input divided voltages of the differential amplifier 61 in accordance with the division cycle signals D0 to D15 and outputs a selected divided voltage as the torque command TRQ. Note that the resistors 62 to 64 do not necessarily need to have the same resistance value. Moreover, the number of the resistors coupled in series is not limited to three.

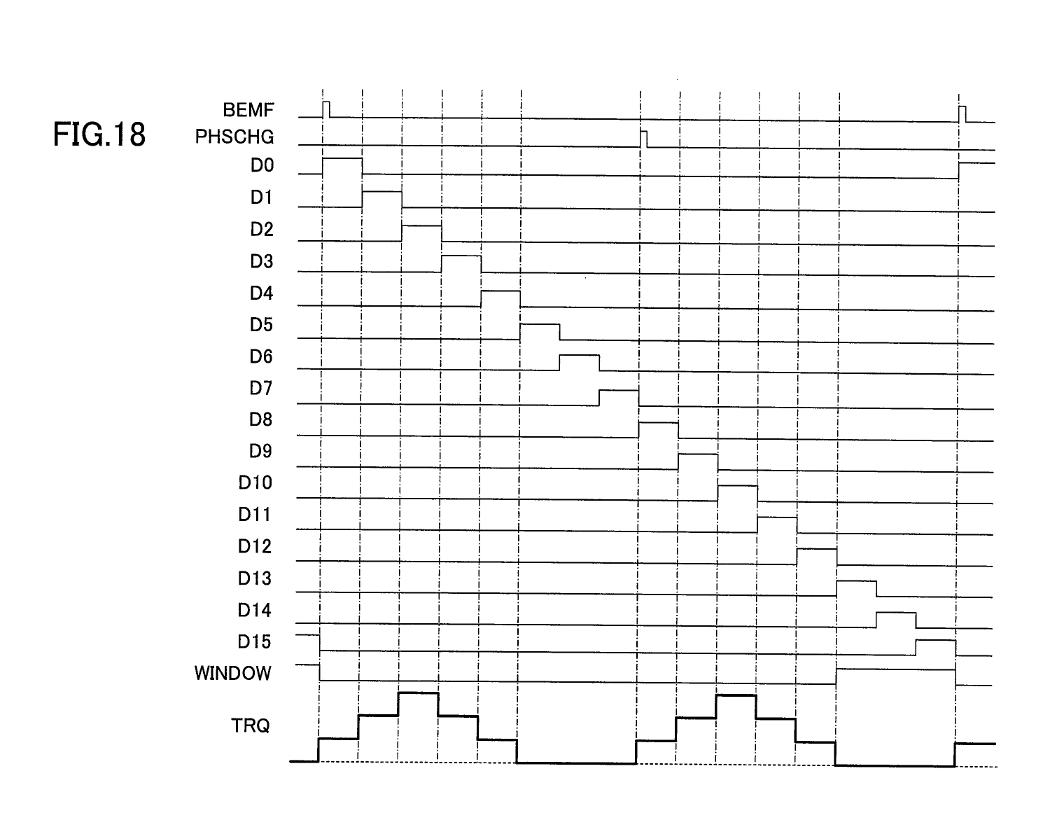

FIG. 18 shows a relationship between the detection signal BEMF, the phase switching signal PHSCHG, the division cycle signals D0 to D15, the window signal WINDOW, and the torque command TRQ. During a period of time that the division cycle signals D0, D4, D8 and D12 are high, the voltage of the resistor 64 is the torque command TRQ. During a period of time that the division cycle signals D1, D3, D9 and D11 are high, the voltage of the resistor 63 is the torque command TRQ. During a period of time that the division cycle signals D2 and D10 are high, the voltage of the resistor 62, i.e., the maximum value is the torque command TRQ. During a period of time that the division cycle signals D5, D6, D7, D13, D14 and D15 are high, the torque command TRQ is a ground potential, i.e., zero. Therefore, the torque command TRQ is set to zero during at least a period of time that the window signal WINDOW is being output.

The number by which one cycle of the detection signal BEMF is divided is not limited to 16. One cycle of the detection signal BEMF may be divided into n equal parts to generate n phases, and the final m of the n phases may be combined to generate the window signal WINDOW. Moreover, during a period of time that the division cycle signals D2 to D10 are high, the window signal WINDOW is not being output, and therefore, the torque command TRQ may have the maximum value.

As described above, according to this embodiment, a torque command is operated to provide a de-energization-in-all-phases period, whereby a motor can be driven within a low-rotational speed range and a back electromotive force can be more accurately detected. Moreover, the torque command is changed in a stepwise manner before and after the torque command is set to zero, whereby the supply of a current to each winding can be smoothly switched on/off. As a result, variations in torque within each cycle can be reduced, and therefore, the motor can be more stably driven at low rotational speed.

Note that all zero-crossings that occur when the back electromotive forces of all windings are changed from a positive value to a negative value, may be detected. Moreover, it is not necessary to detect a zero-crossing for all windings. A zero-crossing which occurs when a back electromotive force is changed from a positive value to a negative value or from a negative value to a positive value, may be detected for any one or two of the windings.

What is claimed is:

1. A motor drive apparatus for PWM control of energization of each of windings of a sensorless motor, comprising:
a zero-crossing detector configured to compare a neutral node voltage of the motor with a back electromotive force of at least one of the windings and output a first signal every time a zero-crossing is detected as a result of the comparison;
a cycle detector configured to detect a cycle of the first signal and output a second signal during a final portion of the cycle; and
a de-energizer configured to de-energize all the windings of the motor during at least a period of time that the second signal is being output, wherein
the zero-crossing detector performs detection of a zero-crossing during the period of time that the second signal is being output.

2. The motor drive apparatus of claim 1, wherein
the de-energizer causes a signal for PWM control of energization of each winding of the motor to be in a high impedance state during the period of time that the second signal is being output.

3. The motor drive apparatus of claim 1, wherein
the cycle detector sets the period of time during which the second signal is being output to be shorter when a torque command is large, and to be longer when the torque command is small.

4. The motor drive apparatus of claim 1, wherein
the cycle detector divides one cycle of the first signal into n equal parts to generate n phases, and combines the final m of the n phases to generate the second signal.

5. The motor drive apparatus of claim 1, wherein
the zero-crossing detector detects a zero-crossing either when the back electromotive force exceeds the neutral node voltage or when the back electromotive force falls below the neutral node voltage.

6. The motor drive apparatus of claim 5, wherein
the zero-crossing detector detects a zero-crossing by comparing the neutral node voltage with the back electromotive force of a specific one of the windings of the motor.

7. A motor drive apparatus for PWM control of energization of each of windings of a sensorless motor, comprising:
a zero-crossing detector configured to compare a neutral node voltage of the motor with a back electromotive force of at least one of the windings and output a first signal every time a zero-crossing is detected as a result of the comparison;
a cycle detector configured to detect a cycle of the first signal and output a second signal during a final portion of the cycle; and
a torque command generator configured to cause a torque command with respect to the motor to be zero during at least a period of time that the second signal is being output, wherein
the zero-crossing detector performs detection of a zero-crossing during the period of time that the second signal is being output.

8. The motor drive apparatus of claim 7, wherein
the torque command generator changes the torque command from a predetermined value to zero and vice versa in a stepwise manner.

9. The motor drive apparatus of claim 7, wherein
the cycle detector divides one cycle of the first signal into n equal parts to generate n phases, and combines the final m of the n phases to generate the second signal.

10. The motor drive apparatus of claim 7, wherein
the zero-crossing detector detects a zero-crossing either when the back electromotive force exceeds the neutral node voltage or when the back electromotive force falls below the neutral node voltage.

11. The motor drive apparatus of claim 10, wherein
the zero-crossing detector detects a zero-crossing by comparing the neutral node voltage with the back electromotive force of a specific one of the windings of the motor.

12. A motor drive method for PWM control of energization of each of windings of a sensorless motor, comprising the steps of:
comparing a neutral node voltage of the motor with a back electromotive force of at least one of the windings and outputting a first signal every time a zero-crossing is detected as a result of the comparison;
detecting a cycle of the first signal and outputting a second signal during a final portion of the cycle; and
de-energizing all the windings of the motor during at least a period of time that the second signal is being output, wherein
detection of a zero-crossing is performed during the period of time that the second signal is being output.

13. The motor drive method of claim 12, wherein
a signal for PWM control of energizetion of each winding of the motor is caused to be in a high impedance state during the period of time that the second signal is being output.

14. The motor drive method of claim 12, wherein
the period of time during which the second signal is being output is set to be shorter when a torque command is large, and to be longer when the torque command is small.

15. The motor drive method of claim 12, wherein
one cycle of the first signal is divided into n equal parts to generate n phases, and the final m of the n phases are combined to generate the second signal.

16. The motor drive method of claim 12, wherein
a zero-crossing is detected either when the back electromotive force exceeds the neutral node voltage or when the back electromotive force falls below the neutral node voltage.

17. The motor drive method of claim 16, wherein
a zero-crossing is detected by comparing the neutral node voltage with the back electromotive force of a specific one of the windings of the motor.

18. A motor drive method for PWM control of energization of each of windings of a sensorless motor, comprising the steps of:
comparing a neutral node voltage of the motor with a back electromotive force of at least one of the windings and outputting a first signal every time a zero-crossing is detected as a result of the comparison;
detecting a cycle of the first signal and outputting a second signal during a final portion of the cycle; and
causing a torque command with respect to the motor to be zero during at least a period of time that the second signal is being output, wherein
detection of a zero-crossing is performed during the period of time that the second signal is being output.

19. The motor drive method of claim 18, wherein
the torque command is changed from a predetermined value to zero and vice versa in a stepwise manner.

20. The motor drive method of claim 18, wherein
one cycle of the first signal is divided into n equal parts to generate n phases, and the final m of the n phases are combined to generate the second signal.

21. The motor drive method of claim 18, wherein
a zero-crossing is detected either when the back electromotive force exceeds the neutral node voltage or when the back electromotive force falls below the neutral node voltage.

22. The motor drive method of claim 21, wherein
a zero-crossing is detected by comparing the neutral node voltage with the back electromotive force of a specific one of the windings of the motor.
